(19) United States
(12) Patent Application Publication
(10) Pub. No.: US 2026/0023007 A1
(43) Pub. Date: Jan. 22, 2026

(54) METHOD FOR CHARACTERIZING THE PATH OF A MOVING PARTICLE IN A SAMPLE

(71) Applicant: COMMISSARIAT A L'ÉNERGIE ATOMIQUE ET AUX ENERGIES ALTERNATIVES, Paris (FR)

(72) Inventors: Ondrej MANDULA, Grenoble Cedex 09 (FR); Guillaume GODEFROY, Grenoble Cedex 09 (FR); Olivier CIONI, Grenoble Cedex 09 (FR)

(73) Assignee: COMMISSARIAT A L'ÉNERGIE ATOMIQUE ET AUX ENERGIES ALTERNATIVES, Paris (FR)

(21) Appl. No.: 19/272,325

(22) Filed: Jul. 17, 2025

(30) Foreign Application Priority Data
Jul. 18, 2024 (FR) FR2407923

(51) Int. Cl. G01N 15/14; G01N 15/10; G01N 15/1434; G06T 7/00; G06T 7/246

(52) U.S. Cl. CPC G01N 15/1459; G01N 15/1434; G06T 7/0016; G06T 7/248; G01N 2015/1006; G01N 2015/1445; G06T 2207/20084; G06T 2207/20221; G06T 2207/30024; G06T 2207/30241

(57) ABSTRACT

Method for characterizing at least one moving particle (10ᵢ) in a sample (10), the method comprising:
a) acquiring at least one image (I, Iₙ) of the sample during an acquisition period, using an image sensor (20) defining a field of view, the acquisition period comprising various acquisition times (tₙ);
b) using the image or each image resulting from a), forming a path image (I) showing the particles of the sample, in the field of view, at the various acquisition times;
c) employing the path image resulting from b) as input image of a detection algorithm programmed to detect particles and of a supervised-learning artificial-intelligence algorithm programmed to compute at least one average movement parameter for various detected particles.

### TECHNICAL FIELD

The technical field of the invention is observation of moving or motile microscopic particles in a sample, with a view to characterization thereof. One application targeted is characterization of spermatozoa.

### PRIOR ART

Observation of motile cell particles, such as spermatozoa, in a sample, is usually performed using a microscope. The microscope comprises an objective defining an object plane lying in the sample, and an image plane coincident with a detection plane of an image sensor. The microscope takes images of the spermatozoa in a focused configuration. The choice of such a modality requires a compromise between spatial resolution, the observed field and the depth of field.

Patent application U.S. Pat. No. 20,240,044771 describes a method for characterizing spermatozoa using a device for acquiring images forming input data of a neural network. The acquiring device may be a defocused or lensless imaging device.

The publication Ershov D “TrackMate 7: integrating state of art segmentation algorithms into tracking pipelines”. Nat Methods 19, 829-832 (2002) describes an application allowing moving particles, cells for example, to be tracked and their morphological characteristics determined. Since the particles are moving, the technique involves acquiring a high number of images. In each image, the particles must be detected and marked, so as to follow their path, so as to determine their movements.

However, current characterizing methods are costly in terms of computation time, in particular when the number of particles is high. It is estimated that the time taken to track each particle varies, depending on the number N of particles, as N³log (N). Furthermore, that is the case in every image. Hence, the computation time may exceed a few tens of seconds when N is several thousand. The time taken to carry out the processing used to characterize the particles must be added to the above.

The inventor proposes a method that is more frugal in terms of computation time, allowing the length of the analysis to be decreased. The method is particularly suitable for characterizing samples containing a high number of cells.

### SUMMARY OF THE INVENTION

A first subject of the invention is a method for characterizing at least one moving particle in a sample, the method comprising:
a) acquiring at least one image of the sample during an acquisition period, using an image sensor defining a field of view, the acquisition period comprising various acquisition times;
b) using the image or each image resulting from a), forming a path image showing the particles of the sample, in the field of view, at the various acquisition times;
c) employing the path image resulting from b) as input image of a detection algorithm programmed to detect the particles and of a supervised-learning artificial-intelligence algorithm programmed to compute at least one average movement parameter for various detected particles.

The supervised-learning artificial-intelligence algorithm may be a convolutional neural network.

According to one possibility, each image of the sample is acquired in a defocused imaging modality or lensless imaging modality, so that each particle forms a diffraction pattern in each image.

According to one possibility:
the sample extends as a sample plane;
the image sensor extends as a detection plane;
an optical system lies between the sample and the image sensor, the optical system defining an object plane and an image plane;
the object plane is offset with respect to the sample plane by an object defocusing distance and/or the image plane is offset with respect to the sample plane by an image defocusing distance, so that, in step a), each image of the sample is acquired in a defocused imaging modality.

According to one possibility, no image-forming optics lie between the sample and the image sensor, so that, in step a), each image of the sample is acquired in a lensless imaging modality.

According to one possibility, each image of the sample is acquired in an interferential imaging modality.

According to one possibility:
step a) comprises acquisition of a plurality of images;
in step b), the path image is obtained through a combination of the images acquired in step a).

The combination may be or include a sum.

According to one possibility:
each acquired image and the path image being defined by pixels,
the value of a given pixel of the path image is the maximum value of said pixel in all the acquired images.

According to one possibility:
each acquired image and the path image being defined by pixels,
the value of a given pixel of the path image is the maximum value of said pixel in all the acquired images.

According to one possibility:
step a) comprises acquisition of a plurality of images;
a holographic reconstruction algorithm is applied to each acquired image, so as to form, from each acquired image, a reconstructed image;
in step b), the path image is obtained through a combination of the reconstructed images. The combination may be or include a sum.

According to one possibility:
during step a), the image is acquired while the sample is subjected to a plurality of successive illuminations, each illumination occurring at one acquisition time;
the path image corresponds to the image acquired in step a).

According to one possibility, step c) comprises, based on the path image:
determining at least one average characteristic of the paths of the particles during the acquisition period;
and/or computing an average particle velocity based on their paths.

According to one possibility, the particles are spermatozoa.

A second subject of the invention is a device for observing a sample, the sample comprising moving particles, the device comprising:
a light source, configured to illuminate the sample;
an image sensor, configured to form an image of the sample;
a holding structure, configured to hold the sample between the light source and the image sensor;
a processing unit, connected to the image sensor, and configured to implement steps b) and c) of a method according to the first subject of the invention based on at least one image acquired by the image sensor.

The invention will be better understood on reading the description of the examples of embodiment that are given, in the remainder of the description, with reference to the figures listed below.

### FIGURES

FIG. 1 shows a first embodiment of a device allowing the invention to be implemented.

FIG. 2 shows a second embodiment of a device allowing the invention to be implemented.

FIG. 3 schematically shows a path of a spermatozoon.

FIG. 4 shows the main steps of a method for characterizing moving particles in the sample.

FIG. 5A shows various images of a sample, acquired at various times.

FIG. 5B shows a path image obtained from images acquired at various times.

FIG. 6A to 6J show a comparison between measurements obtained implementing the invention and real data (ground truth). Each figure relates to one measured characteristic. FIG. 6A shows the number of spermatozoa counted in the field of view. FIGS. 6B to 6F relate to spermatozoa path characteristics. FIGS. 6G to 6J relate to proportions of spermatozoa classified by type in the various samples analysed.

FIGS. 7A to 7J show a Bland-Altman plot of the data shown in FIGS. 6A to 6J, respectively.

FIGS. 8A and 8B show images acquired for various concentrations of spermatozoa.

FIGS. 9A, 9B and 9C show images acquired under various conditions. FIGS. 9D, 9E and 9F show integrated images obtained from the images shown in FIGS. 9A, 9B and 9C, respectively. FIG. 9G shows a path image obtained through a combination of the maxima of elementary images.

### DESCRIPTION OF PARTICULAR EMBODIMENTS

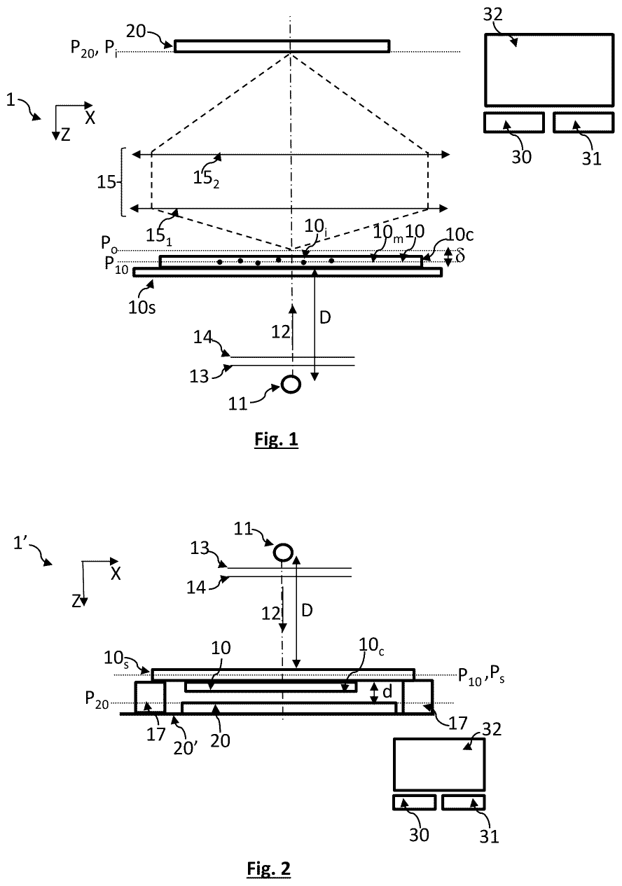

FIG. 1 shows a first embodiment of a device 1 allowing the invention to be implemented. According to this first embodiment, the device allows observation of a sample 10 interposed between a light source 11 and an image sensor 20. The light source 11 is configured to emit an incident light wave 12 that propagates to the sample parallel to a propagation axis Z.

The device comprises a sample holder 10s configured to receive the sample 10, so that the sample is held on the holder 10s. The sample thus held extends as a plane, called the sample plane P₁₀. The sample plane for example corresponds to an average plane around which the sample 10 lies. The sample holder may be a glass slide, for example of 20 μm thickness. Its thickness may be between 10 μm and 1 mm, and preferably between 10 μm and 500 μm or between 10 μm and 100 μm.

The sample notably comprises a liquid medium 10ₘ in which moving and optionally motile particles 10ᵢ are submerged. The medium 10ₘ may be a biological liquid or a buffer liquid. It may for example comprise a bodily liquid, in the pure or diluted state. By bodily liquid, what is meant is a liquid generated by a living body. It may in particular be a question, non-limitingly, of blood, of urine, of cerebrospinal fluid, of semen, or of lymph.

The sample 10 is preferably contained in a fluidic chamber 10_{c}. The fluidic chamber is, for example, a fluidic chamber with a thickness of between 20 μm and 100 μm. The thickness of the fluidic chamber, and therefore of the sample 10, along the propagation axis Z, typically varies between 10 μm and 200 μm, and is preferably between 20 μm and 50 μm.

One of the objectives of the invention is characterization of particles in motion in the sample. In the described example of embodiment, the moving particles are spermatozoa. In this case the sample comprises semen, which may optionally be diluted. In this case, the fluidic chamber 10_{c} may be a counting chamber dedicated to analysis of the mobility or concentration of cells. It may for example be a question of a counting chamber marketed by Leja, with a thickness of between 20 μm and 100 μm.

According to other applications, the sample comprises moving particles, for example microorganisms, for example microalgae or plankton, or cells, for example cells in the process of sedimentation.

The distance D between the light source 11 and the sample 10 is preferably greater than 1 cm. It is preferably between 2 and 30 cm, and for example 5 cm.

Advantageously, the light source 11, as seen by the sample, may be considered to be a point source. This means that its diameter (or its diagonal) is preferably less than one tenth, better still one hundredth of the distance between the sample and the light source.

The light source 11 is for example a light-emitting diode. In the described

example, the light is emitted at a wavelength of 450 nm. It is preferably associated with a diaphragm 14, or spatial filter. The aperture of the diaphragm is typically between 5 μm and 1 mm, and preferably between 50 μm and 1 mm. In this example, the diaphragm has a diameter of 400 μm. In another configuration, the diaphragm may be replaced by an optical fibre, a first end of which is placed facing the light source and a second end of which is placed facing the sample 10. The device may also comprise a diffuser 13, placed between the light source 11 and the diaphragm 14. The use of a diffuser/diaphragm assembly is for example described in U.S. Pat. No. 10,418,399.

The image sensor 20 is configured to form an image of the sample in a detection plane P₂₀. In the example shown, the image sensor 20 comprises a matrix array of CCD or CMOS pixels. The detection plane P₂₀ is preferably perpendicular to the propagation axis Z. The image sensor preferably has a large sensing area, typically greater than 10 mm². In this example, the image sensor is an IDS-UI-3160CP-M-GL, comprising pixels of 4.8×4.8 μm², the sensing area being 9.2 mm×5.76 mm, i.e. 53 mm².

In the example shown in FIG. 1, the image sensor 20 is optically coupled to

the sample 10 by an optical system 15. In the example shown, the optical system comprises an objective 151 and a tube lens 152. The latter is intended to project a formed image onto the sensing area of the image sensor 20 (area of 53 mm²). The image acquisition frequency is for example 60 images per second, the exposure time being 2 ms per image.

In this example:
The objective 15₁ is a Motic CCIS EF-N Plan Achromat 10x with a numerical aperture of 0.25.
The lens 15₂ is a Thorlabs LBF254-075-A—focal length 75 mm.

Such a set-up yields a field of view of 3 mm², with a spatial resolution of 1 μm.

The optical system 15 defines an object plane Pₒ and an image plane Pᵢ. In the embodiment shown in FIG. 1, the image sensor 20 is configured to acquire an image in a defocused configuration. The image plane Pᵢ is coincident with the detection plane P₂₀, while the object plane Pₒ is offset by an object defocusing distance δ of between 10 μm and 500 μm, with respect to the sample. The defocusing distance is preferably between 50 μm and 200 μm, and for example 100 μm. The object plane Pₒ lies outside the sample 10. According to another possibility, the object plane lies in the sample, while the image plane is offset with respect to the detection plane by an image defocusing distance. The image defocusing distance is preferably between 50 μm and 200 μm, and for example 100 μm. According to another possibility, the object plane Pₒ and the image plane Pᵢ are both offset with respect to the sample plane and with respect to the detection plane, respectively. Whatever the retained configuration, the defocusing distance is preferably greater than 10 μm and less than 1 mm, or even 500 μm, and preferably between 50 μm and 150 μm. Observation of a cellular sample in a defocused configuration has been described in the patent U.S. Pat. No. 10,545,329.

One advantage of defocused imaging is that it makes it possible to observe translucent or transparent particles, with a satisfactory contrast.

According to one possibility, each acquired image may be subjected to a digital reconstruction algorithm, so as to improve spatial resolution. It is known that use of digital reconstruction algorithms makes it possible to obtain sharp images of particles. Such algorithms are for example described in each of U.S. Pat. No. 10,564,602, U.S. Pat. No. 20,190,101484and U.S. Pat. No. 20,200,124586. In this type of algorithm, based on a hologram acquired in a detection plane, an image of the sample is reconstructed in a reconstruction plane that is distant from the detection plane. It is conventional for the reconstruction plane to extend through the sample. However, this type of algorithm may require a relatively long computation time. The invention has proved to be effective, in the case of the characterization of spermatozoa, when images acquired by the image sensor (holograms) are employed without implementation of the reconstruction algorithm.

It is known that lensless imaging, coupled with holographic reconstruction algorithms, allows observation of transparent or translucent cells while maintaining a large field of view, and a large depth of field. The patents U.S. Pat. No. 9,588,037 and U.S. Pat. No. 8,842,901for example describe the use of lensless imaging to observe spermatozoa. The patents U.S. Pat. No. 10,481,076 and U.S. Pat. No. 10,379,027 also describe the use of lensless imaging, coupled with reconstruction algorithms, to characterize cells.

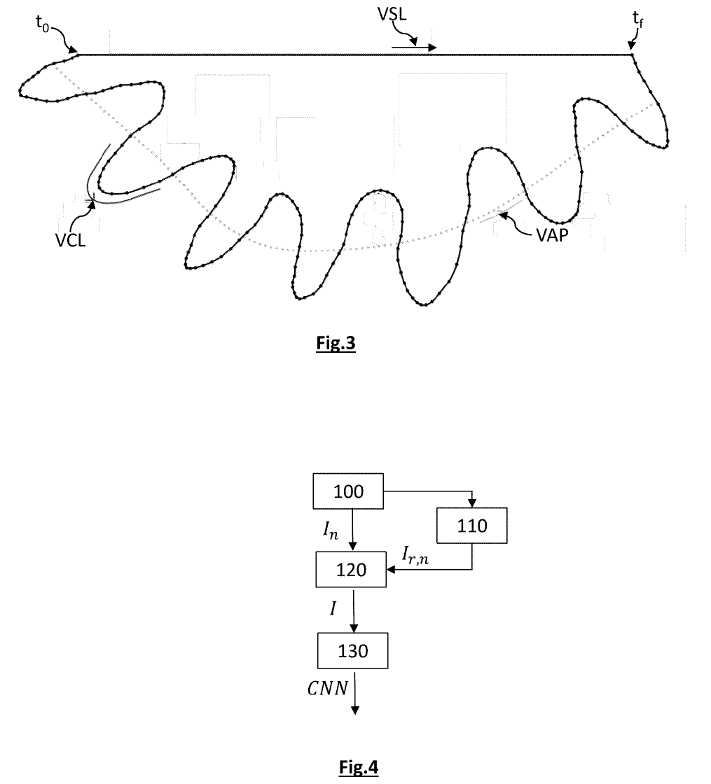

FIG. 2 shows a second embodiment of a device 1′ suitable for implementing the invention. The device 1′ comprises a light source 11, a diffuser 13, a diaphragm 14, an image sensor 20, a holding structure 17 and a processing unit 30 such as described in connection with the first embodiment. The holding structure 17 is configured to define a fixed distance between the sample and the image sensor. According to this embodiment, the device does not comprise any image-forming lenses between the image sensor 20 and the sample 10. The image sensor 20 is preferably close to the sample, the distance between the image sensor 20 and the sample 10 typically being between 100 μm and 3 mm. According to this embodiment, the image sensor acquires images in a lensless imaging modality. The sample is preferably contained in a fluidic chamber 10_{c}, for example a “Leja” chamber such as described in connection with the first embodiment. The advantage of such an embodiment is that it does not require an optical system 15 to be precisely positioned with respect to the sample 10, and that it ensures a large field of view. The drawback is that images of lower quality are obtained; however, they remain usable.

Other interferometric or diffraction imaging systems may be used. It may for example be a question of phase-contrast imaging systems.

The imaging modalities described above are suitable for transparent or translucent particles. When the particles are sufficiently opaque, it is possible to employ a conventional imager, focused on the sample.

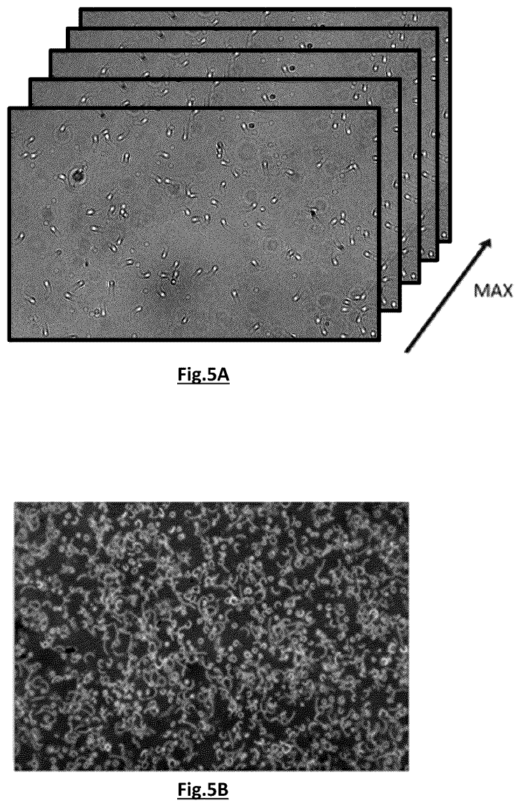

FIG. 3 illustrates a path of a spermatozoon, between an initial time t₀ and a final time t_{f}. Each dot illustrates one position of one spermatozoon, at a time t between t₀ and t_{f}.

From the path, it is possible to characterize the movement of a spermatozoon, by determining various characteristics, for example:
a velocity straight-line path VSL, which corresponds to the velocity computed on the basis of a distance, in a straight line, between the first and last points of the path, corresponding to the initial and final times of the acquisition, respectively;
a velocity curvilinear path VCL: this is a velocity determined by summing the distances travelled between two successive times, and multiplying by the acquisition frequency;
a velocity average path VAP: this is a velocity determined after smoothing the path of a particle-the distance travelled along the smoothed path (or average path) is divided by the time between the initial time and the final time. In FIG. 3, the average path has been represented by a dotted line.

On the basis of the computed velocities, it is possible to define indicators allowing the motility of the spermatozoa to be characterized, these indicators being known to those skilled in the art. It is for example a question of indicators such as:

an indicator of straightness STR, obtained by taking the ratio of VSL and VAP. The more the spermatozoon moves in a straight line, the closer this indicator gets to 1;
an indicator of linearity LIN, obtained by taking the ratio of VSL and VCL. The more the spermatozoon moves in a straight line, the closer this indicator also gets to 1.

Quantification of the velocities or parameters listed above allows spermatozoa to be categorised depending on their motility. For example, a spermatozoon is considered to be:
motile if the length of the path is greater than a first threshold, for example 10 pixels, and its movement along the average path (VCL×Δt, Δt being the acquisition period) is greater than a predefined length, corresponding for example to the length of a spermatozoon head;
progressive if the length of the path is greater than the first threshold, and if the straightness STR and velocity average path VAP are greater than two threshold values STRₜₕ and VAPₜₕ₁, respectively;
slow if the length of the path is greater than the first threshold and if the velocity straight-line path VSL and the velocity average path VAP are less than two threshold values VSLₜₕ₂ and VAPₜₕ₂, respectively;
static if the length of the path is greater than the first threshold and if the velocity straight-line path VSL and the velocity average path VAP are less than two threshold values VSLₜₕ₃ and VAPₜₕ₃, respectively;
uncategorised if the length of the path is less than the first threshold.

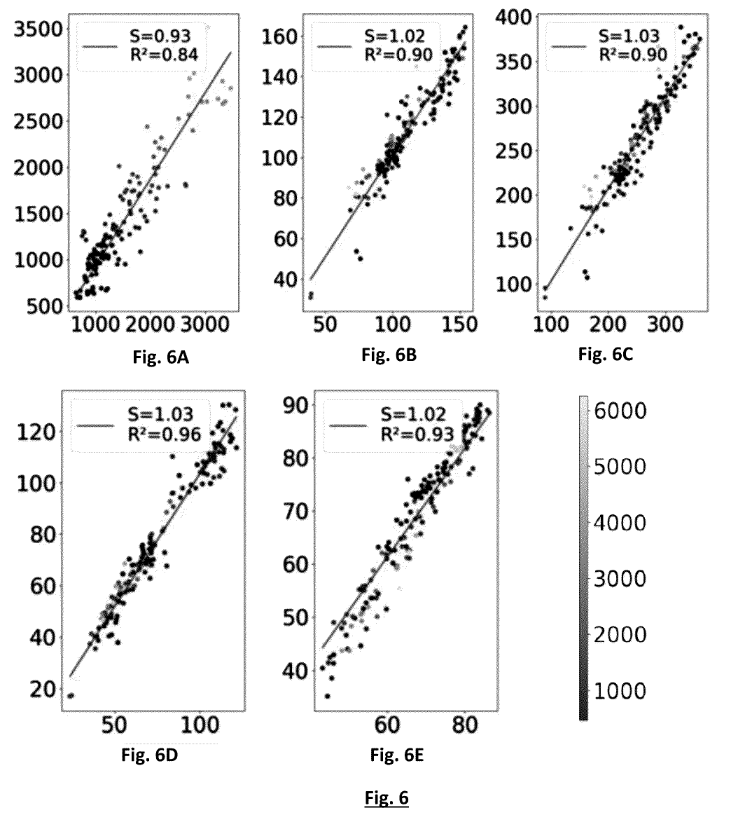

FIG. 4 schematically shows the main steps of a method for processing a plurality of images acquired by an image sensor in the defocused imaging modality. The method is described with reference to the observation of spermatozoa, but it will be understood that it may be applied to the observation of other types of motile particles.

### Step 100: Acquisition of a Series of Images Iₙ.

During this step, images of the sample are acquired at various acquisition times tₙ, each time corresponding to one acquired image Iₙ. The acquisition times lie between an initial time and a final time. A stack of acquired images is obtained, as shown in

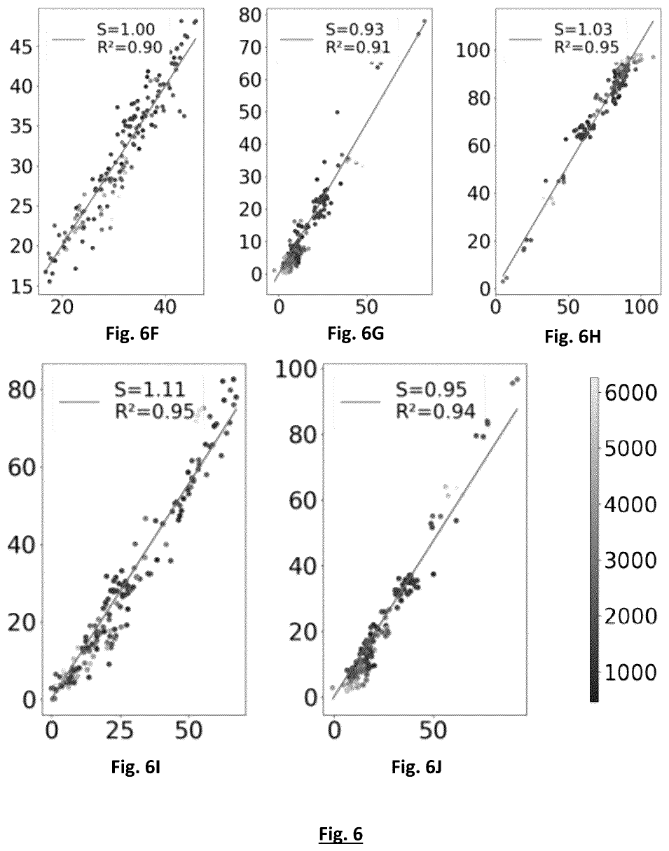

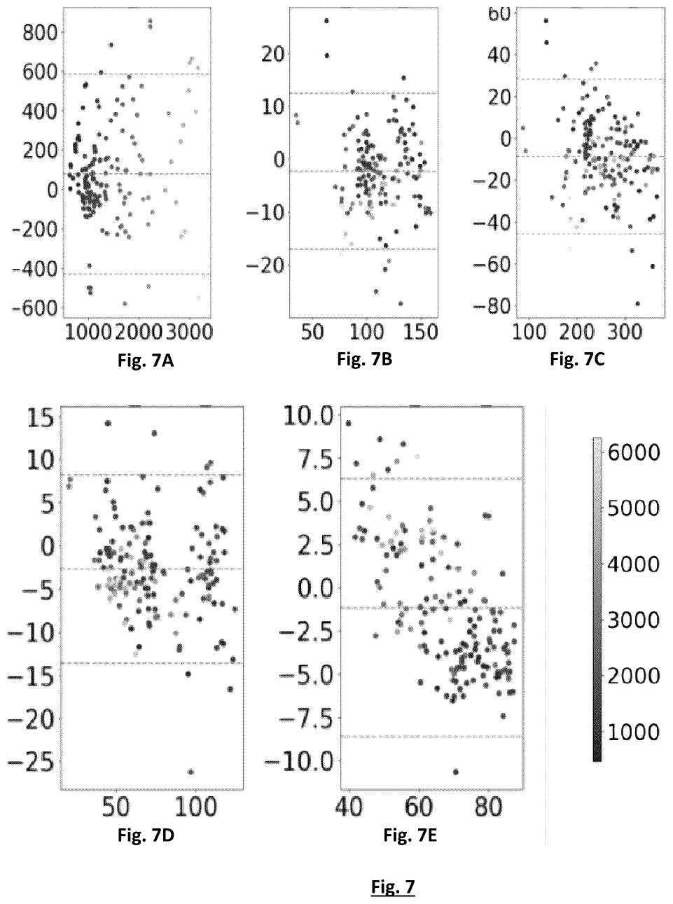

FIG. 5A.

### Step 110: Holographic Reconstruction (Optional Step)

During this step, a holographic reconstruction algorithm is applied to each acquired image Iₙ, so as to form an image I_{r,n}, of the sample at each acquisition time tₙ. This step is not essential.

### Step 120: Formation of a Path Image

During this step, a path image I is formed. The term path image designates the fact that the image makes it possible to estimate the respective paths of a plurality of particles of the sample. Given the density of particles, the path image shows the successive positions of several tens or even several hundreds or thousands of particles, between the initial time and the final time. The path image may be formed through a combination of the images Iₙ acquired in step 100 or of the images I_{r,n} reconstructed in step 110.

Each acquired image Iₙ is defined by pixels r. r designates a coordinate in the detection plane defined by the image sensor.

One way of obtaining the path image I is to take, for each pixel (x, y), an extreme value of all of the acquired or reconstructed images Iₙ, I_{r,n}.

To establish the path image, the maximum value of each acquired image (or of each reconstructed image) may be taken into account.

The value of each pixel of the path image is then

$$I ( x , y ) = {max}_{n} {I}_{n} ( x , y ) . \qquad ( 1 )$$

Obtaining a path image is an important aspect of the invention. The path image shows a position of the particles, in the field of view of the image sensor, at the various acquisition times. Thus, the path image makes it possible to view the path of the particles of the sample, in the field of view, at the various acquisition times. FIG. 5B shows one example of a path image obtained through a combination of 30 acquired images.

Unlike the prior art, multiple images of the same particle at various acquisition times are not formed. The invention differs from the prior art in that it combines, in the same image, the various images of the sample at the various acquisition times.

### Step 130: Detection and Characterization of the Motion of Each Particle.

During this step, the path image is used as input datum of a detection algorithm configured to detect the particles and optionally count them. It may be a question of a particle-tracking algorithm, such as Trackmate 7, as described in the prior art.

The path image is also used as input datum of a characterization algorithm configured to compute metrics allowing average characteristics of the motion of the detected particles to be determined. It is for example a question of average velocity or motility characteristics such as described above.

The characterization algorithm may be a supervised artificial-intelligence algorithm, for example a convolutional neural network (CNN). It may for example be a question of the neural network described in Tan M. et al “EfficientNet: Rethinking Model Scaling for Convolutional Neural Networks”, available at arxiv.org/pdf/1905.11946. This is an algorithm configured to perform a particular imaging task.

This algorithm was trained, so as to allow the average characteristics VSL, VCL, VAP, STR, LIN to be determined in the sample. The algorithm was then tested on various samples. One particularity of the test was that the concentrations of spermatozoa in the various samples were variable.

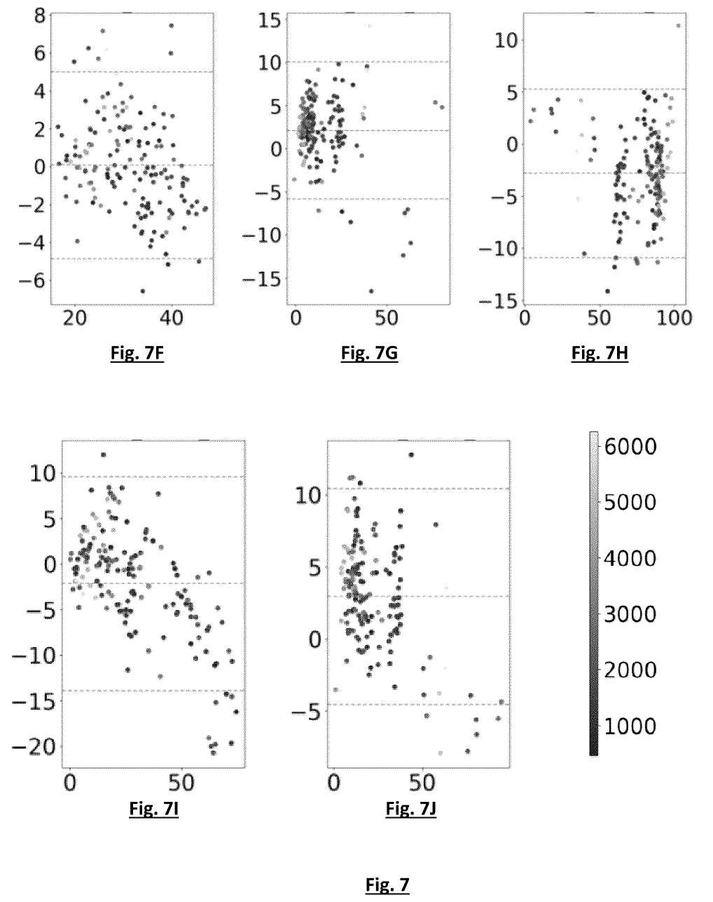

FIGS. 6A to 6F show, for various respective characteristics, the real characteristics (ground truth-x-axis) as a function of the estimates obtained implementing steps 100 to 140 described above (y-axis). FIG. 6A shows the number of spermatozoa in the field of view for various samples (y-axis: estimate-x-axis: ground truth). It may be seen that the number of spermatozoa observed, in a given image, varies between a few hundred and about 6000. It is estimated that an image showing 3000 spermatozoa corresponds to a spermatozoa concentration of 60 million per mL. In FIG. 6A, each point corresponds to one sample.

The characteristics shown in FIGS. 6B to 6F are average values of respective characteristics of paths of spermatozoa in the various samples. It is a question of average values of VAP, VCL, VSL and STR and LIN for the spermatozoa of the various samples, respectively. Each point represents one sample. The greyscale of each point depends on the number of spermatozoa in the field of view, for the sample to which the analysed spermatozoon belongs. For each characteristic, a linear regression model, represented by a solid line, was established. A linear correlation coefficient S and a linear coefficient of determination R2 were also computed for each characteristic.

In each of FIGS. 6B to 6F, the x-axis corresponds to the ground truth, and the y-axis corresponds to an estimate obtained, for each sample, by implementing the invention.

From the determined characteristics, a percentage of static spermatozoa (FIG. 6G), motile spermatozoa (FIG. 6H), progressive spermatozoa (FIG. 6I), and slow spermatozoa (FIG. 6J) in each sample were determined. FIGS. 6G to 6J show the percentages estimated for each category of spermatozoa (y-axis) and the ground-truth percentages obtained using a reference method, with implementation of a tracking algorithm and estimation of all of the mobility characteristics for the various detected spermatozoa.

Table 1 shows, for each characteristic studied, the linear correlation coefficient S and a linear coefficient of determination R2.

TABLE 1

| parameter | figure | S | R2 |
|---|---|---|---|
| number | 6A | 0.93 | 0.84 |
| VAP | 6B | 1.02 | 0.9 |
| VCL | 6C | 1.03 | 0.9 |
| VSL | 6D | 1.03 | 0.96 |
| STR | 6E | 1.02 | 0.93 |
| LIN | 6F | 1.00 | 0.90 |
| % static | 6G | 0.93 | 0.91 |
| % motile | 6H | 1.03 | 0.95 |
| % progressive | 6I | 1.11 | 0.95 |
| % slow | 6J | 0.95 | 0.94 |

Table 1 shows that the linearity coefficient and coefficient of correlation are close to 1, attesting to the relevance of the estimation of each characteristic with the algorithm based on a convolutional neural network.

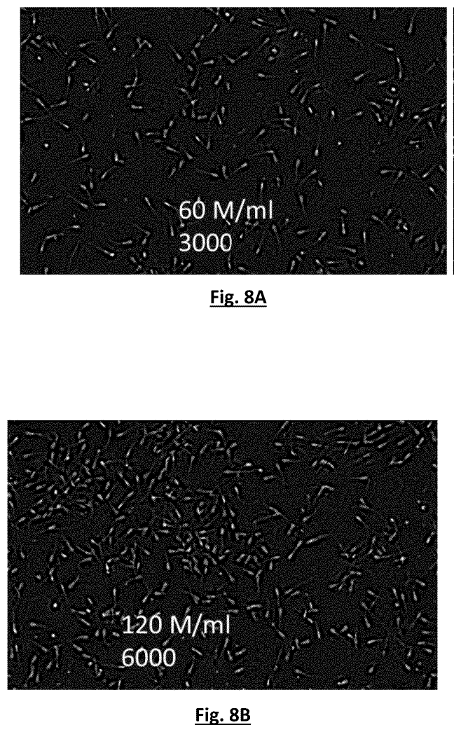

FIGS. 7A to 7J are Bland-Altman plots corresponding to the characteristics discussed in connection with FIGS. 6A to 6J, respectively. In each of these plots:
the y-axis shows a difference between each estimated value and each ground-truth value;
the x-axis shows an average between each estimated value and each ground-truth value.

It is possible to conclude, from FIGS. 7A to 7J, that systematic error is absent.

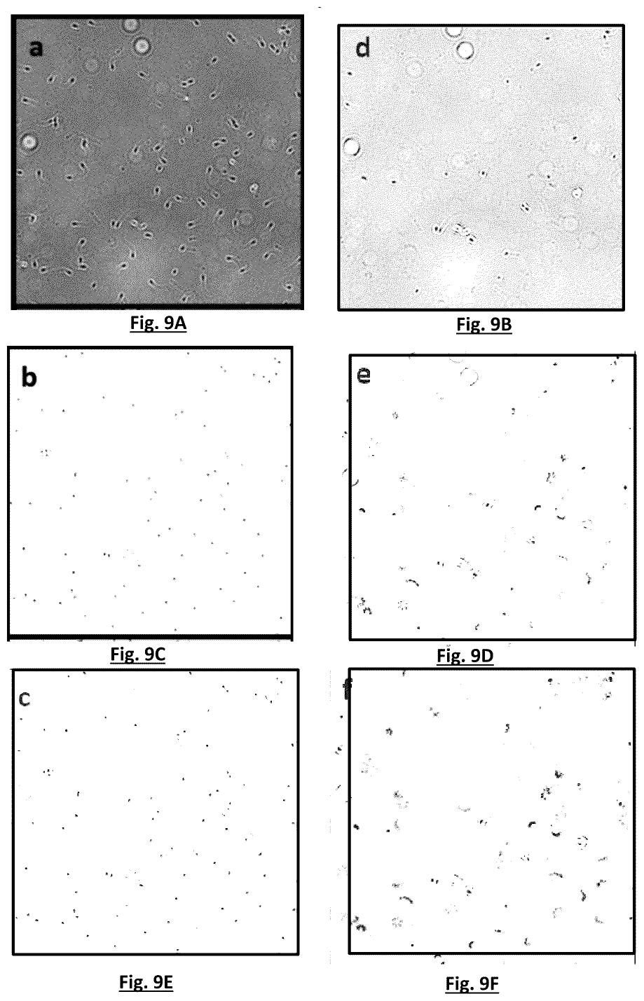

FIGS. 8A and 8B show examples of segments of images of samples respectively containing 3000 and 6000 spermatozoa, corresponding to spermatozoa concentrations equal to 60 M/ml and 120 M/ml, respectively. It is believed that the method described above is applicable, in the case of spermatozoa, to concentrations of up to 80 M/ml. Beyond this concentration, the number of spermatozoa in the field of view of the image sensor gets too high. The maximum concentration depends on the instrumentation used and on the type of particles. The maximum concentration may be determined beforehand, on the basis of simulations or experimental trials.

### Variants

According to one possibility, the path image is formed not from the maxima of each acquired image Iₙ, according to (1), but by a sum of each acquired image Iₙ (or each reconstructed image).

Thus,

$$I = {\sum }_{n} {I}_{n} \qquad ( 2 )$$

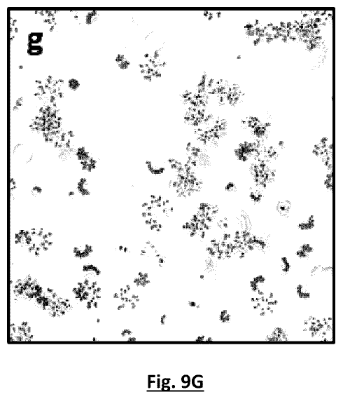

FIG. 9A shows one example of a reconstructed image. FIG. 9D shows a sum of 30 images.

In the case where the path image is formed by image summation, it is however preferable for each summed image to have been thresholded (see FIG. 9B), or to have had an LUT applied (for example a gamma LUT: see FIG. 9C). This allows for more readily exploitable integrated images to be obtained: see FIG. 9E (summation of thresholded images) or FIG. 9F (summation of images having undergone correction with a gamma LUT). The integrated images shown in FIGS. 9E and 9F are more readily exploitable.

Thus, during formation of a path image as described in (2), it is preferable for each summed image to have been subjected to prior processing. The path image is then comparable to an image obtained according to (1). FIG. 9G shows an image obtained according to (1), from images such as the one shown in FIG. 9A. The processing may be performed in the camera or by a software package.

According to another variant, the path image may be an image acquired with an exposure time corresponding to the acquisition period. The sample is then illuminated stroboscopically by successive light pulses, each light pulse corresponding to one acquisition time.

The invention allows moving particles in a sample to be characterized by means of a fast processing operation. It is essentially a question of counting particles and/or of determining characteristics related to their path in the sample. In the case of spermatozoa, certain paths are specific to a morphological peculiarity. It is therefore possible to obtain information about the morphology of the spermatozoa by characterizing their paths. Thus, the algorithm may allow morphological information to be obtained indirectly through path analysis.

1. A method for characterizing at least one moving particle in a sample, the method comprising:
a) acquiring at least one image of the sample during an acquisition period, using an image sensor defining a field of view, the acquisition period comprising various acquisition times;
b) based on the image or each image resulting from a), forming a path image showing the particles of the sample, in the field of view, at the said various acquisition times;
c) using the path image resulting from b) as input image of a detection algorithm programmed to detect the particles and of a supervised-learning artificial-intelligence algorithm programmed to compute at least one average speed for the detected particles.

2. The method according to claim 1, wherein the supervised-learning artificial-intelligence algorithm is a convolutional neural network.

3. The method according to claim 1, wherein each image of the sample is acquired in a defocused imaging modality or lensless imaging modality, so that each particle forms a diffraction pattern in each image.

4. Method according to claim 3, wherein:
the sample extends as a sample plane;
the image sensor extends as a detection plane;
an optical system lies between the sample and the image sensor, the optical system defining an object plane and an image plane;
the object plane is offset with respect to the sample plane by an object defocusing distance and/or the image plane is offset with respect to the sample plane by an image defocusing distance, so that, in step a), each image of the sample is acquired in a defocused imaging modality.

5. The method according to claim 1, wherein each image of the sample is acquired in a lensless imaging modality, so that each particle forms a diffraction pattern in each image.

6. The method according to claim 5, wherein no image-forming optics lie between the sample and the image sensor, so that, in step a), each image of the sample is acquired in a lensless imaging modality.

7. The method according to claim 1, wherein each image of the sample is acquired in an interferential imaging modality.

8. The method according to claim 1, wherein:
step a) comprises acquisition of a plurality of images;
in step b), the path image is obtained through a combination of the images acquired in step a).

9. The method according to claim 8, wherein the combination is a sum.

10. The method according to claim 8, wherein
each acquired image and the path image being defined by pixels,
the value of a given pixel of the path image is the maximum value of said pixel in all the acquired images.

11. The method according to claim 1, wherein:
step a) comprises acquiring a plurality of images;
a holographic reconstruction algorithm is applied to each acquired image, so as to form, from each acquired image, a reconstructed image;
in step b), the path image is obtained through a combination of the reconstructed images.

12. The method according to claim 1, wherein
during step a), the image is acquired while the sample is subjected to a plurality of successive illuminations, each illumination occurring at one acquisition time;
the path image corresponds to the image acquired in step a).

13. The method according to claim 1, wherein the particles are motile within the sample.

14. The method according to claim 1, wherein
the particles are spermatozoa;
step c) comprises, based on the path image:
determining at least one average characteristic of the paths of the spermatozoa during the acquisition period;
and/or computing an average spermatozoa velocity based on their paths.

15. A device for observing a sample, the sample comprising moving particles, the device comprising:
a light source, configured to illuminate the sample;
an image sensor, configured to form an image of the sample;
a holding structure, configured to hold the sample between the light source and the image sensor;
a processing unit, connected to the image sensor, and configured to implement) steps b) and c) of the method according to claim 1 based on at least one image acquired by the image sensor.
